(19) United States
(12) Patent Application Publication
(10) Pub. No.: US 2025/0183344 A1
(43) Pub. Date: Jun. 5, 2025

(54) MANIFOLD FOR SOLID OXIDE FUEL CELL, METHOD FOR REFORMING AMMONIA USING THE MANIFOLD, AND SOLID OXIDE FUEL CELL INCLUDING THE MANIFOLD

(71) Applicant: Korea Institute of Science and Technology, Seoul (KR)

(72) Inventors: Sungeun YANG, Seoul (KR); Ji-Won SON, Seoul (KR); Minjun OH, Seoul (KR); Jong Ho LEE, Seoul (KR); Seongkook OH, Seoul (KR); Kyung Joong YOON, Seoul (KR); Ho-il JI, Seoul (KR)

(21) Appl. No.: 18/637,857

(22) Filed: Apr. 17, 2024

(30) Foreign Application Priority Data
Nov. 30, 2023 (KR) 10-2023-0170693

(51) Int. Cl. H01M 8/2484; H01M 8/04007; H01M 8/0606; H01M 8/12; H01M 8/1246; H01M 8/2457

(52) U.S. Cl. CPC H01M 8/2484; H01M 8/04074; H01M 8/0606; H01M 8/1246; H01M 8/2457; H01M 2008/1293

(57) ABSTRACT

The present exemplary embodiments provide a manifold for a solid oxide fuel cell including: a first tube which is positioned on a side surface of the manifold and protrudes to the outside; a second tube which is positioned on a side surface of the manifold different from the surface on which the first tube is positioned and protrudes to the outside of the manifold; a fluid flow space connected to the first tube; and a plurality of branch tubes connected to the second tube, wherein the plurality of branch tubes is disposed inside the fluid flow space.

### CROSS-REFERENCE TO RELATED APPLICATION

This application claims priority to and the benefit of Korean Patent Application No. 10-2023-0170693 filed in the Korean Intellectual Property Office on Nov. 30, 2023, the entire contents of which are incorporated herein by reference.

### BACKGROUND OF THE INVENTION

### (a) Field of the Invention

The present exemplary embodiments relate to a manifold for a solid oxide fuel cell, a method for reforming ammonia using the manifold, and a solid oxide fuel cell including the manifold.

### (b) Description of the Related Art

A fuel cell is a device which directly converts chemical energy of fuel into electrical energy, and has merits of significantly high energy efficiency and almost no emission of pollutants as compared with a common heat engine.

Among the fuel batteries, since a solid oxide fuel cell operates at a high temperature in a range of 600 to 1000° C., various fuels such as gas including ammonia or hydrocarbon as well as hydrogen may be freely used through internal reforming without a fuel reformer. In addition, fuel such as ammonia or hydrocarbon has a merit of easier transportation and storage than hydrogen.

When ammonia or hydrocarbon is used as the fuel of the solid oxide fuel cell, there are two ways in which the fuel is directly injected into a cell or injected into a cell after partial reforming. When an ammonia or hydrocarbon fuel is directly used, nickel which is a constituent material of a solid oxide fuel cell may act as a reforming catalyst, but may be insufficient for achieving sufficient reformation. Thus, a part of the fuel needs to be reformed before it reaches the cell.

A method of disposing a separate catalytic reactor outside a stack is currently used, but when the separate catalytic reactor is disposed, the volume of a solid oxide fuel cell system is increased, a heat exchange system for heat exchange between the stack and the catalytic reactor is needed, and system cost and volume are increased.

Therefore, a study of performing both heat exchange and fuel reformation in a manifold for a solid oxide fuel cell which may overcome the problems was performed, thereby completing the present disclosure.

### SUMMARY OF THE INVENTION

The present disclosure attempts to provide a manifold for a solid oxide fuel cell capable of performing both heat exchange and fuel reforming inside the manifold and improving efficiency of heat exchange and fuel reforming through a plurality of branch tubes, a method for reforming ammonia using the manifold, and a solid oxide fuel cell including the manifold.

An exemplary embodiment of the present disclosure provides a manifold for a solid oxide fuel cell including: a first tube which is positioned on a side surface of the manifold and protrudes to the outside; a second tube which is positioned on a side surface of the manifold different from the surface on which the first tube is positioned and protrudes to the outside of the manifold; a fluid flow space connected to the first tube; and a plurality of branch tubes connected to the second tube, wherein the plurality of branch tubes is disposed inside the fluid flow space.

A first fluid moving in the fluid flow space and a second fluid moving in the plurality of branch tubes may move in a cross-over manner.

Heat exchange may be performed between the first fluid moving in the fluid flow space and the second fluid moving in the plurality of branch tubes.

When the first tube is an inflow tube, the second tube may be an outflow tube of the second fluid.

When the first fluid is a raw material including ammonia, the second fluid may be heated air.

A residence volume % of the first fluid which moves in the fluid flow space may be in a range of 40 to 90 volume % based on 100% of the volume of the manifold.

An outer diameter of a single branch tube in the plurality of branch tubes may be in a range of 1.0 to 20.0 mm.

A catalyst coating layer may be included on the inside or outside of the plurality of branch tubes.

A catalyst may be filled into the inside of the plurality of branch tubes or the inside of the fluid flow space.

The plurality of branch tubes may include one or more metals selected from the group consisting of iron (Fe), nickel (Ni), chromium (Cr), ruthenium (Ru), cobalt (Co), molybdenum (Mo), osmium (Os), platinum (Pt), and copper (Cu).

Another exemplary embodiment of the present disclosure provides a method for reforming ammonia using a manifold for a solid oxide fuel cell which is the manifold for a solid oxide fuel cell of claim 1, including: flowing ammonia into a first tube, wherein a temperature at an inlet and a temperature at an outlet of a fluid flow space of ammonia satisfy the following Equation 1:

$$30. \% \leq ( \vert B - A \vert / A ) * 100 \leq 200. \% \qquad [ Equation 1 ]$$

wherein A is the temperature (° C.) at the inlet of the fluid flow space of ammonia, and B is the temperature (° C.) at the outlet of the fluid flow space of ammonia.

A temperature range in the inlet of the fluid flow space of ammonia may be 20 to 600° C., and a temperature range in the outlet of the fluid flow space of ammonia may be 400 to 1100° C.

In the method for reforming ammonia, an ammonia conversion rate inside the manifold may satisfy the following 2:

$$15 \% \leq 100 * ( C - D ) / C \leq 100 \% \qquad [ Equation 2 ]$$

wherein C is a supply ammonia flow rate (L/min) at a manifold inflow position of fuel, and D is a residual ammonia flow rate (L/min) at a manifold outflow position of fuel.

Still another exemplary embodiment of the present disclosure provides a solid oxide fuel cell including: an upper manifold; repeating units including cells and separation plates; and a lower manifold, wherein the lower manifold is the manifold of claim 1, and the repeating units include a first fluid channel connected to the upper manifold and the lower manifold and a second fluid channel connected to the upper manifold and the lower manifold.

According to the present exemplary embodiment, the manifold for a solid oxide fuel cell is intended to provide a manifold for a solid oxide fuel cell in which both heat exchange and fuel reforming are carried out, by including a plurality of branch tubes.

In addition, the method for reforming ammonia using the manifold for a solid oxide fuel cell of the above exemplary embodiment may improve heat exchange performance and increase reactivity of a catalyst with effective heat transfer to improve fuel reforming efficiency.

In addition, the solid oxide fuel cell including the manifold for a solid oxide fuel cell of the above exemplary embodiment may decrease a volume of a solid oxide fuel cell system.

### BRIEF DESCRIPTION OF THE DRAWINGS

FIG. 1 is a drawing showing a solid oxide fuel cell assembly including a manifold of the present disclosure.

FIG. 2 is a drawing showing a solid oxide fuel cell including the manifold of the present disclosure by each constituent element.

FIG. 3 is a drawing showing a lower manifold.

FIG. 4 is an internal perspective view of the lower manifold.

FIG. 5 is a drawing expressing fuel and air flows in tubes inside the manifold.

FIG. 6 is a cross-sectional view of a catalyst-uncoated tube and a catalyst-coated tube.

FIG. 7 is a basic modeling drawing of Example 1 of the present disclosure in a COMSOL 3D Multiphysics simulation.

FIG. 8 is a modeling drawing showing a temperature distribution depending on ammonia reforming in Example 1 of the present disclosure in the COMSOL 3D Multiphysics simulation.

FIG. 9 is a modeling drawing showing a temperature distribution depending on ammonia reforming in Comparative Example 1 of the present disclosure in the COMSOL 3D Multiphysics simulation.

FIG. 10 is a modeling drawing showing an ammonia concentration distribution depending on ammonia reforming in Example 1 of the present disclosure in the COMSOL 3D Multiphysics simulation.

FIG. 11 is a modeling drawing showing an ammonia concentration distribution depending on ammonia reforming in Comparative Example 1 of the present disclosure in the COMSOL 3D Multiphysics simulation.

FIG. 12 is a modeling drawing showing a temperature distribution depending on ammonia reforming in Example 2 of the present disclosure in the COMSOL 3D Multiphysics simulation.

FIG. 13 is a modeling drawing showing an ammonia concentration distribution depending on ammonia reforming in Example 2 of the present disclosure in the COMSOL 3D Multiphysics simulation.

FIG. 14 is a modeling drawing showing a temperature distribution depending on ammonia reforming in Example 3 of the present disclosure in the COMSOL 3D Multiphysics simulation.

FIG. 15 is a modeling drawing showing an ammonia concentration distribution depending on ammonia reforming in Example 3 of the present disclosure in the COMSOL 3D Multiphysics simulation.

FIG. 16 is a modeling drawing showing a temperature distribution depending on ammonia reforming in Comparative Example 2 of the present disclosure in the COMSOL 3D Multiphysics simulation.

FIG. 17 is a modeling drawing showing an ammonia concentration distribution depending on ammonia reforming in Comparative Example 2 of the present disclosure in the COMSOL 3D Multiphysics simulation.

FIG. 18 is a modeling drawing showing a temperature distribution depending on ammonia reforming in Example 4 of the present disclosure in the COMSOL 3D Multiphysics simulation.

FIG. 19 is a modeling drawing showing an ammonia concentration distribution depending on ammonia reforming in Example 4 of the present disclosure in the COMSOL 3D Multiphysics simulation.

FIG. 20 is a modeling drawing showing a temperature distribution depending on ammonia reforming in Example 5 of the present disclosure in the COMSOL 3D Multiphysics simulation.

FIG. 21 is a modeling drawing showing an ammonia concentration distribution depending on ammonia reforming in Example 5 of the present disclosure in the COMSOL 3D Multiphysics simulation.

### DETAILED DESCRIPTION OF THE EMBODIMENTS

The terminology used herein is only for mentioning a certain example, and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

The terms such as first, second, and third are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

In addition, unless particularly mentioned, % refers to wt %, and unless the unit is separately stated, a unit based on moles is omitted.

In the present specification, the term “combination(s) thereof” described in the Markush format refers to a mixture or combination of one or more selected from the group consisting of the constituent elements described in the Markush format, and refers to inclusion of one or more selected from the group consisting of the constituent elements.

Hereinafter, exemplary embodiments of the present disclosure will be described in detail. However, these are suggested only as an example and the present disclosure is not limited thereby, and the present disclosure is only defined by the scope of the claims described later.

### Manifold for Solid Oxide Fuel Cell

As described above, a part of fuel needs to be reformed before being introduced to a cell, before the fuel reaches the cell. In the present exemplary embodiment, a manifold in which a plurality of branch tubes is disposed inside a fluid flow space is implemented to reform fuel before being introduced to a cell, thereby meeting the need.

Specifically, a manifold for a solid oxide fuel cell according to an exemplary embodiment includes: a first tube which is positioned on a side surface of the manifold and protrudes to the outside; a second tube which is positioned on a side surface of the manifold different from the surface on which the first tube is positioned and protrudes to the outside of the manifold; a fluid flow space connected to the first tube; and a plurality of branch tubes connected to the second tube, wherein the plurality of branch tubes is disposed inside the fluid flow space.

Herein, a first fluid moving in the fluid flow space and a second fluid moving in the plurality of branch tubes may move in a cross-over manner.

Herein, heat exchange may be performed between the first fluid moving in the fluid flow space and the second fluid moving in the plurality of branch tubes.

Herein, the first tube may be an inflow tube or an outflow tube of first fluid, and in this case, the second tube may be an outflow tube or an inflow tube of the second fluid. Specifically, when the first tube is the inflow tube of the first fluid, the second tube may be the outflow tube of the second fluid.

Herein, the first fluid may be a raw material including ammonia or heated air, and in this case, the second fluid may be heated air or a raw material including ammonia. Specifically, when the first fluid is a raw material including ammonia, the second fluid may be heated air.

The raw material is a material introduced for producing electrical energy using the solid oxide fuel cell, and specifically, refers to a fuel used in a solid oxide fuel cell and a material including a material before being converted to the corresponding fuel. In the specification, fuel may be used in the meaning of including the raw material.

Herein, a residence volume % of the first fluid moving in the fluid flow space may be in a range of 40 to 90 volume %, specifically 45 to 85 volume %, 50 to 85 volume %, 55 to 85 volume %, or 60 to 85 volume %, based on 100% of the volume of the manifold.

The volume of the manifold which is used as a standard when calculating the residence volume % of the first fluid may be calculated from the product of the width×length×height of the manifold, and the residence volume % of the first fluid based on 100 volume % of the manifold may be calculated by dividing the volume of the first fluid present in the fluid flow space by the volume of the manifold and multiplying by 100.

When the residence volume % of the first fluid moving in the fluid flow space falls below the range, pressure drop becomes severe and an inflow to a first fluid channel and an outflow to the first tube of repeating units including cells and separation plates may not be performed well, and when it exceeds the range, heat exchange of the fluid may not be sufficiently performed.

In addition, an outer diameter of a single branch tube in the plurality of branch tubes may be in a range of 1.0 to 20.0 mm, preferably 1.5 to 16.0 mm, 2.0 to 14.0 mm, 2.5 to 12.0 mm, or 3.0 to 10.0 mm. The range is a numerical range which is properly predetermined considering processability, pressure drop, and volume of the manifold.

When the range is satisfied, more efficient heat exchange occurs in the manifold and a fluid flow appropriate for heat exchange is formed, thereby shortening a total process time. When it exceeds the range, the diameter of the single branch tube is excessively large, so that a sufficient number of branch tubes may not be disposed and only a small number of branch tubes may be disposed, and thus, a total surface area in contact with the fluid in the fluid flow space in the plurality of branch tubes is decreased to lower heat exchange efficiency and ammonia conversion efficiency, and when it is below the range, a pressure difference between the inside and the outside of a stack may occur due to a pressure drop.

The manifold for a solid oxide fuel cell may include a catalyst coating layer on the inside or outside of the plurality of branch tubes.

Herein, the catalyst coating layer of the branch tube may have a thickness in a range of 0.003 μm to 100 μm, preferably 0.005 μm to 50 μm, 0.01 μm to 30 μm, 0.1 μm to 30 μm, or 1 μm to 20 μm.

When it exceeds the range, heat exchange between the first fluid flowing in the fluid flow space and the second fluid flowing in the plurality of branch tubes is not performed well due to the catalyst coating layer, and heat exchange efficiency and ammonia conversion rate may be lowered or fluid flow may be interrupted, and when it is below the range, it is difficult to see an effect of forming the catalyst coating layer and it may be difficult to increase the conversion effect.

The manifold for a solid oxide fuel cell may be filled with the catalyst inside the plurality of branch tubes or outside the fluid flow space.

The catalyst may be one or more single metal catalysts selected from the group consisting of 4^{th} period transition metals, 5^{th} period transition metals, and 6^{th} period transition metals, an alloy catalyst, or a metal nitride catalyst, and specifically, may be one or more catalysts selected from the group consisting of nickel (Ni), iron (Fe), cobalt (Co), ruthenium (Ru), molybdenum (Mo), and osmium (Os). Specifically, the catalyst may be a single metal catalyst, an alloy catalyst, or a metal nitride catalyst, and the catalyst active material may be a catalyst in the form of being supported on an oxide or a carbon material.

In addition, the plurality of branch tubes of the manifold for a solid oxide fuel cell may be formed of one or more metals selected from the group consisting of iron (Fe), nickel (Ni), chromium (Cr), ruthenium (Ru), cobalt (Co), molybdenum (Mo), osmium (Os), platinum (Pt), and copper (Cu). Specifically, the metal may include nickel, iron, and chromium. Herein, the metal means inclusion of a metal or a metal oxide. When the plurality of branch tubes is formed of a metal including nickel, iron, and chromium, heat exchange and a catalytic reaction may be better performed at the same time, and stability at high temperature may be better due to formation of an oxide coat of chromium.

### Method for Reforming Ammonia Using Manifold for Solid Oxide Fuel Cell

Ammonia reforming in the present specification is used in the same meaning of ammonia conversion, and means a reaction to produce nitrogen and hydrogen through ammonia decomposition. Ammonia reforming may be represented by a reaction of the following Chemical Formula 1:

2NH₃→N₂+3H₂ [Chemical Formula 1]

A method for reforming ammonia using a manifold for a solid oxide fuel cell may include: flowing ammonia into a first tube, wherein a temperature at an inlet and a temperature at an outlet of a fluid flow space of ammonia satisfy the following Equation 1:

$$30. \% \leq ( \vert B - A \vert / A ) * 100 \leq 200. \% \qquad [ Equation 1 ]$$

wherein A is the temperature (° C.) at the inlet of the fluid flow space of ammonia, and
B is the temperature (° C.) at the outlet of the fluid flow space of ammonia. Herein, a range of (|B−A|/A)*100 may be 40.0% to 175.0% or 50.0% to 150.0%.

When it is below the range, ammonia does not sufficiently exchange heat inside the manifold and an ammonia conversion rate may be lowered, and when it exceeds the range, structural instability due to a difference in temperature in the manifold may occur.

Herein, a temperature range at the inlet of the fluid flow space of ammonia may be 20 to 600° C., 30 to 550° C., 50 to 500° C., 100 to 450° C., 200 to 400° C., or 300 to 400° C., and a temperature range at the outlet of the fluid flow space of ammonia may be 400 to 1100° C., 400 to 1000° C., 450 to 950° C., 500 to 900° C., or 500 to 800° C.

In the method for reforming ammonia using a manifold for a solid oxide fuel cell, an ammonia conversion rate inside the manifold may satisfy the following Equation 2:

$$15 \% \leq 100 * ( C - D ) / C \leq 100 \% \qquad [ Equation 2 ]$$

wherein C is a supply ammonia flow rate (L/min) at a manifold inflow position of fuel, and
D is a residual ammonia flow rate (L/min) at a manifold outflow position of fuel.

More specifically, the range of (100*(E−F)/E) may be 15% to 100%, 25% to 100%, 35% to 100%, 45% to 99.5%, or 45% to 95%.

When it is below the range, a reformation rate is low, so that fuel cell performance may be deteriorated.

### Solid Oxide Fuel Cell

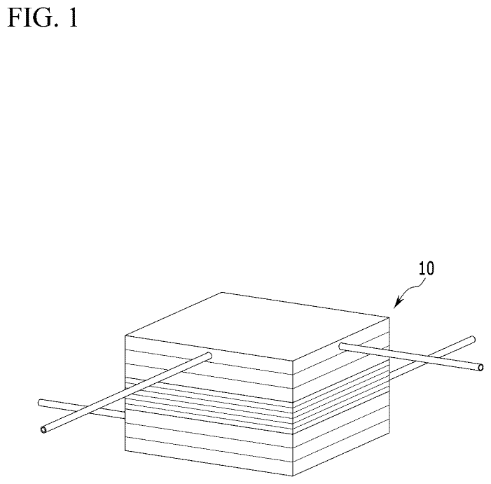

A solid oxide fuel cell may include: an upper manifold, repeating units including cells and separation plates; and a lower manifold, as shown in FIG. 1, wherein the upper manifold or lower manifold is one of the manifolds described above, and the repeating units include a first fluid channel connected to the upper manifold and the lower manifold and a second fluid channel connected to the upper manifold and the lower manifold.

A manifold which is not the manifold described above is a manifold which does not include a plurality of branch tubes inside a fluid flow space of the manifold.

The repeating units of cells and separation plates are units which actually make performance during fuel cell operation, include cells, and are formed of a structure in which the separation plate for separating each cell, that is, layer, a sealing material, a current collector for collecting the cell, and the like are repeated.

Herein, the lower manifold may be one of the manifolds described above.

When the lower manifold is one of the manifolds described above, a possibility of deformation of the repeating units is decreased due to a weight increased by arrangement of the plurality of branch tubes, as compared with the case in which the upper manifold is one of the manifolds described above, so that stability of the solid oxide fuel cell may be increased.

Hereinafter, the examples of the present disclosure will be described in detail. However, these are suggested only as an example and the present disclosure is not limited thereby, and the present disclosure is only defined by the scope of the claims described later.

### Manifold for Solid Oxide Fuel Cell and Solid Oxide Fuel Cell

FIG. 1 is a drawing showing a solid oxide fuel cell assembly including the manifold according to an exemplary embodiment of the present disclosure, that is, a combination of each constituent element.

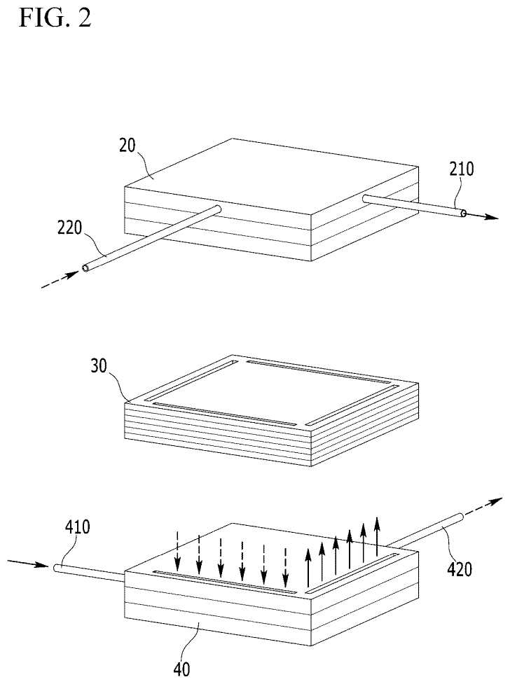

Referring to FIG. 2 showing the solid oxide fuel cell by each constituent element, in the solid oxide fuel cell including the manifold according to an exemplary embodiment of the present disclosure, an upper manifold 20 including a fuel outflow tube 210 connected to the outside (outside of the manifold) and an air inflow tube 220 connected to the outside, repeating units 30 of cells and separation plates, and a lower manifold 40 including a fuel inflow tube 410 connected to the outside and an air outflow tube 420 connected to the outside are laminated.

The repeating units 30 of cells and separation plates are units which actually make performance during fuel cell operation, include cells, and are formed of a structure in which the separation plate for separating each cell (layer), a sealing material, a current collector for collecting the cell, and the like are repeated.

In FIG. 2, a dotted arrow represents a flow of heated air flowing in and a flow of air flowing out after heat exchange inside the manifold. Specifically, the heated air may flow into the upper manifold 20 through the air inflow tube 220 connected to the outside, move toward a surface opposite to the inflow surface inside the upper manifold, flow into an air channel of the repeating units 30 of cells and separation plates, move toward a surface opposite to the surface flowing into the repeating units of cells and separation plates inside the repeating units of cells and separation plates, flow into the lower manifold 40, move toward a surface opposite to the inflow surface inside the lower manifold, and then flow out through the air outflow tube 420 connected to the outside.

Meanwhile, a solid arrow represents a flow of a raw material including ammonia flowing in and a flow of the raw material flowing out after heat exchange inside the manifold. Specifically, the raw material including ammonia may flow into the lower manifold 40 through the fuel inflow tube 410 connected to the outside, move toward a surface opposite to the inflow surface inside the lower manifold, flow into a fuel channel (separated from the air channel) of the repeating units 30 of cells and separation plates, move toward a surface opposite to the surface flowing into the repeating units of cells and separation plates inside the repeating units of cells and separation plates, flow into the upper manifold 20, move toward a surface opposite to the inflow surface inside the upper manifold, and then flow out through the fuel outflow tube 210 connected to the outside.

For reference, the directions of the air flow and the fuel flow described in the present specification are not fixed. Specifically, fuel may move along an air movement path and air may move along a fuel movement path.

In the present disclosure, since heat exchange between exhaust air at a high temperature passing through the repeating units and fuel put into a stack is intended, the inlet positions of fuel and air are divided into an upper and a lower portion.

For reference, the manifold according to an exemplary embodiment of the present disclosure may be disposed in the upper or lower portion, or in both the upper and the lower portions. In the present specification, the manifold according to an exemplary embodiment of the present disclosure is disposed in the lower manifold.

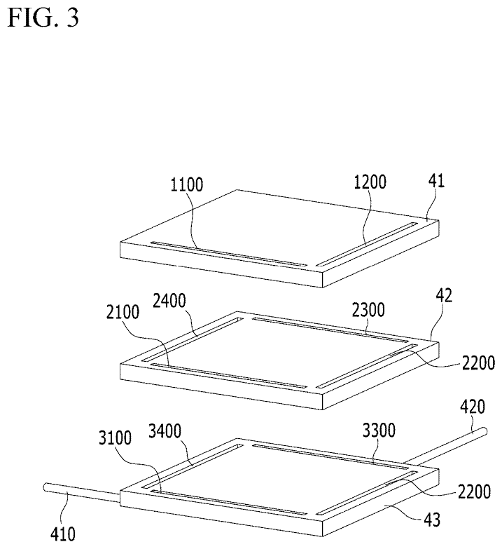

Referring to FIG. 3 showing the lower manifold 40, the manifold according to an exemplary embodiment of the present disclosure is configured by laminating a first stack 41, a second stack 42, and a third stack 43 in the lower manifold. Herein, the number of stack laminations may be properly adjusted considering a stack capacity and reaction efficiency intended in the manifold.

Each stack includes flow paths 1100 to 3400 through which air and fuel move. Specifically, exhaust air at a high temperature which passes through the repeating units and comes down may flow into the manifold through a first flow path 1100 of air and be connected to the air outflow tube 420 of the stack, and input fuel may flow in through the air inflow tube 410 of the stack, exchange heat with the air at a high temperature, and then flow into the stack repeating units through a fifth flow path 1200.

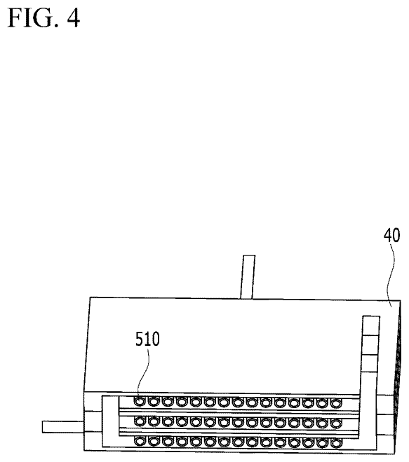

FIG. 4 is an internal perspective view of the lower manifold 40, and a channel through which fuel passes, that is, a fluid flow space and an air moving branch tube 510 may be confirmed. It may be confirmed that the fluid flow space and the air moving branch tube are vertically arranged. Meanwhile, an inner diameter, an outer diameter, and a thickness of the branch tube and the air moving branch tube may vary depending on the manufacturing method. For reference, a channel indicated vertically long in the right side is the part where the fifth flow path 1200 of fuel, a fourth flow path 2200 of fuel, and a third flow path 3200 of fuel are shown when each stack of the lower manifold is assembled.

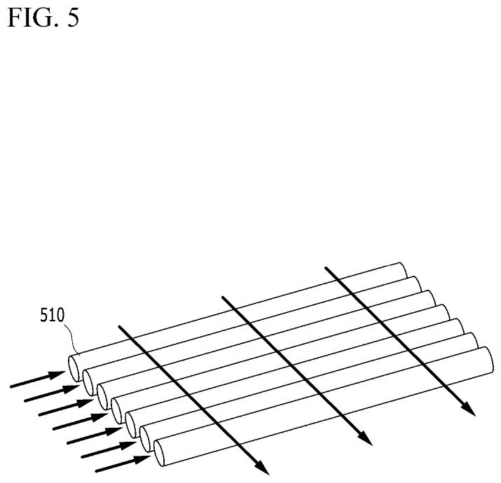

FIG. 5 is a drawing simulating a flow going through the inside and the outside of the branch tube, and air at a high temperature (short arrow) passing through the inside of the branch tube may exchange heat with fuel at low temperature (long arrow) passing through the outside of the branch tube. The surface area may be increased by the branch tube repeating structure as such to increase heat exchange efficiency.

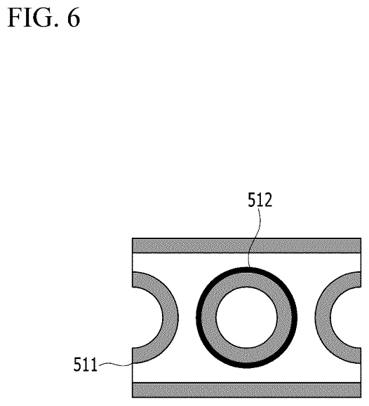

FIG. 6 is a drawing schematizing the coating or uncoating of a catalyst, and is a cross-sectional view of a catalyst-uncoated tube and a catalyst-coated tube. A branch tube including a surface catalyst layer 512 of the catalyst-coated branch tube may be applied to the manifold. The catalyst may be directly applied to the branch tube where heat exchange occurs to improve heat exchange and catalytic reactivity.

Specifically, the catalyst may be introduced by the following method.

Since the catalytic reaction may occur also in the tube or the branch tube, the tube or the branch tube itself may be one or more catalysts selected from the group consisting of nickel (Ni), iron (Fe), cobalt (Co), ruthenium (Ru), molybdenum (Mo), and osmium (Os). Specifically, the catalyst may be a single metal catalyst, an alloy catalyst, or a metal nitride catalyst, and the catalytically active material may be a catalyst in the form of being supported on an oxide or a carbon material.

In addition, the inside or the outside of the branch tube may be coated with the catalyst. When fuel, specifically a raw material including ammonia moves inside the branch tube, it is preferred to coat the inside of the branch tube with the catalyst, and when the fuel moves in the fluid flow space outside the branch tube, it is preferred to coat the outside of the branch tube with the catalyst.

In addition, the inside of the branch tube may be filled with the catalyst. This should be the case in which fuel, specifically a raw material including ammonia moves inside the branch tube.

Since the catalytic reaction is an endothermic reaction and may accelerate heat exchange as the catalytic reaction occurs and the catalytic reaction is activated at a high temperature, when a catalyst layer exists in the part near the tube or the branch tube where heat exchange occurs well, the catalytic reaction is activated.

### Heat Exchange and Ammonia Reforming Experiment Using COMSOL 3D Multiphysics Modeling Simulation

During heat exchange and ammonia reforming in the manifold according to the present disclosure, in order to understand and predict a heat exchange efficiency difference and an ammonia conversion rate difference depending on the manifold configuration modelling (such as whether the branch tube is included), “Transport of Concentrated species”, “Free and Porous Media Flow”, and “Heat transfer in Solids and Fluids” module available from COMSOL Multiphysics™ which is commercial simulation software were used to calculate a steady-state three-dimensional heat and mass transfer.

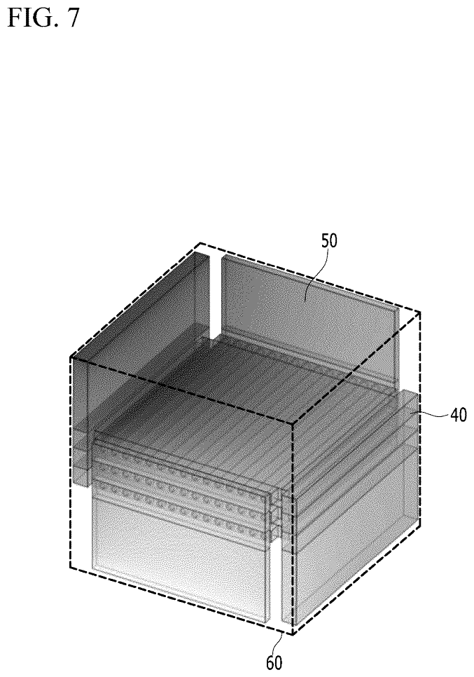

FIG. 7 is a basic modelling drawing of Example 1 in the COMSOL 3D Multiphysics simulation.

Stack inlet and outlet of the raw material including ammonia and the heated air were assumed to be in a cross-over form. It was assumed that air at a high temperature flows through the branch tube, and a raw material including ammonia flows in the fluid flow space.

In modeling, the lower manifold 40 had the width×length of 175 mm×175 mm, the height of one stack where a plurality of branch tubes is positioned in the fluid flow space was 13.0 mm, and a total of three corresponding stacks were laminated to form 39.0 mm.

In one layer of the manifold, the number of branch tubes inside was set to 15, and the outer diameter was 6.0 mm, the inner diameter was 4.0 mm, and the length was 145.0 mm in a single branch, so that the total volume of the plurality of branch tubes were 0.273×10⁻⁴ m³ per one layer based on the inner diameter.

In the modeling, a flow path extension 50 was further included in the lower manifold 40. The flow path extension was included for offsetting back-diffusion due to a hydrogen concentration which increases as a reforming reaction occurs. In addition, since the stack is operated in a Hot-Box, appropriate thermal boundary needs to be considered, and the outermost part 60 of an assembly including the manifold and the flow path extension was assumed. The width×length of the outermost part corresponds to 175 mm×175 mm, and simulation was performed by setting a part corresponding to the width×length of 200 mm×200 mm to an insulator condition.

In addition, fuel flowed in from the outside and the air flowed into the manifold through the stack, and at this time, the temperature of air flowing in was 700° C. which was the stack temperature, and the temperature of fuel was assumed to be 400° C., since the fuel is generally affected by the Hot-Box, an electric furnace, or an additional preheater.

In addition, a stack having the conditions as described below was assumed, and the details were as follows.
Basic condition
1V
20A/cell
25 cell in stack
Assuming fuel utilization rate of 50%: about 7.5 liter/min
Assuming air utilization rate of 100%, 10%: about 9 or 90 liter/min

The air utilization rate refers to (air amount used in electrochemical reaction of fuel cell/air amount put into stack)*100. Specifically, the air utilization rate of 100% means that the air amount put into the stack is all used in the electrochemical reaction of the fuel cell.

Likewise, the fuel utilization rate refers to (fuel amount used in electrochemical reaction of fuel cell/fuel amount put into stack)*100.

Both the air utilization rate and the fuel utilization rate determine air and fuel flow rates required by a current density (A). The air utilization rate was assumed to be 100% and 10% for convenience, and when it is considered to be 100% at the corresponding current density, the utilization rate may vary when a current density is lowered or the number of cells changes. The flow rate conditions in each experiment described later are described in detail in the corresponding paragraph.

The ammonia conversion rate was calculated as the ammonia flow rate at the inlet and the ammonia flow rate the outlet of the manifold. Specifically, it was calculated by dividing a value obtained by subtracting a residual ammonia flow rate (L/min) at the manifold outflow position of fuel from a supply ammonia flow rate (L/min) at the manifold inflow position of fuel by the supply ammonia flow rate and then multiplying by 100.

### (1) Experimental Example 1—Comparison of Heat Exchange and Ammonia Conversion Efficiency Depending on Whether Branch Tube was Included

Simulation was performed in order to compare heat exchange and ammonia conversion efficiency depending on whether a branch tube was included, in Comparative Example 1 which was a model not including a plurality of branch tubes and Example 1 which was a model including the plurality of branch tubes.

As described above, in order to observe the heat exchange in the manifold, it was assumed that a temperature of fuel put into the manifold was 400° C. and a temperature of air was 700° C. In addition, detailed assumption conditions were as follows:
Assumption conditions of Experimental Example 1
Assuming fuel utilization rate of 50%
Assuming air utilization rate of 100%

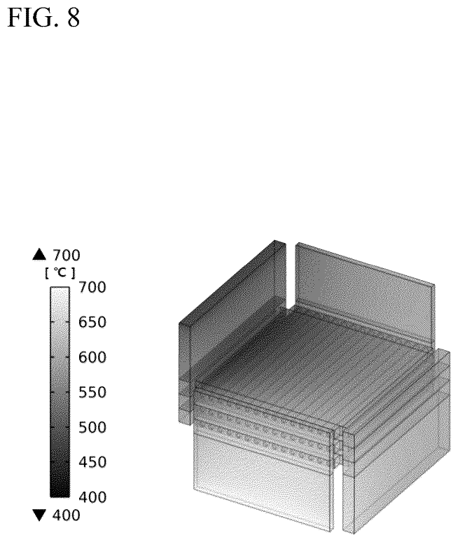

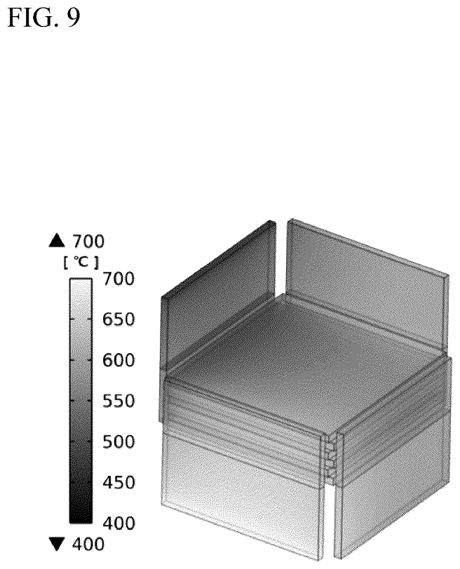

FIG. 8 is a modeling drawing showing a temperature distribution depending on ammonia reforming in Example 1 of the present disclosure in the COMSOL 3D Multiphysics simulation, and FIG. 9 is a modeling drawing showing a temperature distribution depending on ammonia reforming in Comparative Example 1 of the present disclosure in the COMSOL 3D Multiphysics simulation.

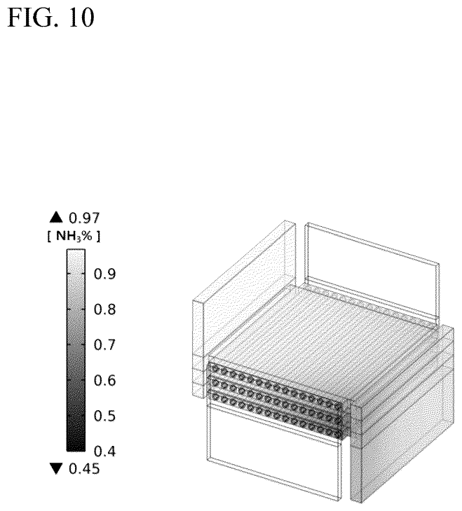

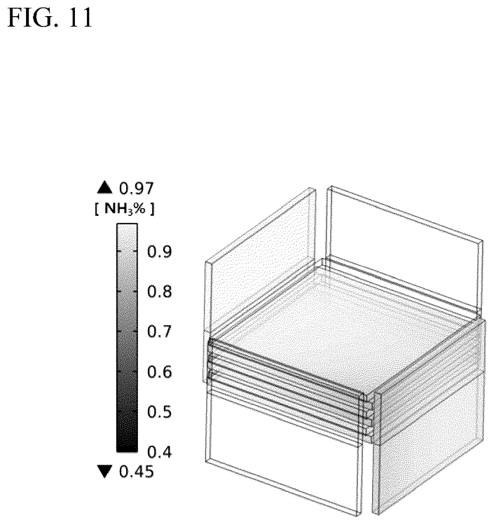

In addition, FIG. 10 is a modeling drawing showing an ammonia concentration distribution depending on ammonia reforming in Example 1 of the present disclosure in the COMSOL 3D Multiphysics simulation, and FIG. 11 is a modeling drawing showing an ammonia concentration distribution depending on ammonia reforming in Comparative Example 1 of the present disclosure in the COMSOL 3D Multiphysics simulation.

Details are shown in the following Table 1.

TABLE 1

| | Example | Comparative |
|---|---|---|
| | 1 | Example 1 |
| Air temperature at air inflow part of manifold | 700 | 700 |
| (° C.) | | |
| Air temperature at air outflow part of | 559 | 583 |
| manifold (° C.) | | |
| Fuel temperature (A) at fuel inflow part of | 400 | 400 |
| manifold (° C.) | | |
| Fuel temperature (B) at fuel outflow part of | 599 | 569 |
| manifold (° C.) | | |
| (\|B − A\|/A)*100 (%) | 49.75 | 42.25 |
| Ammonia conversion rate (%) | 11.5 | 5.2 |

That is, the temperature rises of Comparative Example 1 which was a model which did not include a plurality of branch tubes and Example 1 which was a model including the plurality of branch tubes were 169° C. and 199° C., respectively, and a fuel temperature rise of Example 1 was higher by 30° C. The outlet temperature of air was also lowered by 25° C. in the design of Example 1 of the present disclosure, and it was found that heat exchange was better performed in Example 1 of the present disclosure.

In addition, since the reactivity of the ammonia reforming greatly varied depending on the temperature, it was found that the ammonia reforming rate of Example 1 was twice or more that of Comparative Example 1. For reference, the ammonia reforming rate may be further increased by coating the branch tube included in the present disclosure with an appropriate catalyst.

### (2) Experimental Example 2—Comparison of Heat Exchange and Ammonia Conversion Efficiency Depending on Ammonia Reforming Reaction Performance

Simulation was performed in order to confirm change in heat exchange and ammonia conversion efficiency depending on ammonia reforming reaction performance change, by comparing Example 1 with Example 2 in which only the performance of an ammonia reforming reaction occurring in a plurality of branch tubes was changed in Example 1. Since the ammonia reforming reaction is an endothermic reaction and a reforming rate may be a cause of lowering temperature, confirmation through the corresponding experiment was needed.

Specifically, Example 2 was modeled by setting the reaction rate constant of the ammonia decomposition reaction applied in Example 1 to ⅓ times. The simulation was performed with the other conditions remaining the same. It was assumed that the temperature of fuel put into the manifold was 400° C. and the temperature of air was 700° C., as in Example 1. In addition, detailed assumption conditions were as follows.
Assumption conditions of Experimental Example 2
Assuming fuel utilization rate of 50%
Assuming air utilization rate of 100%

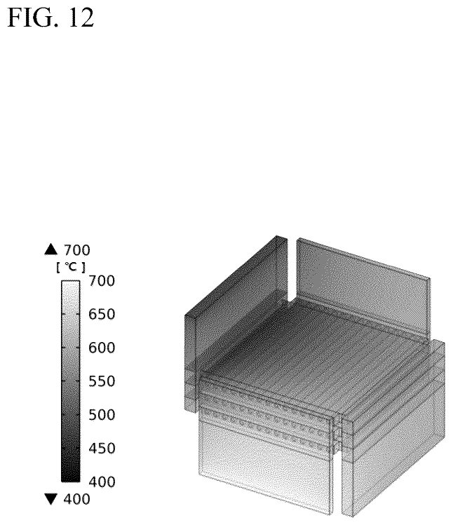

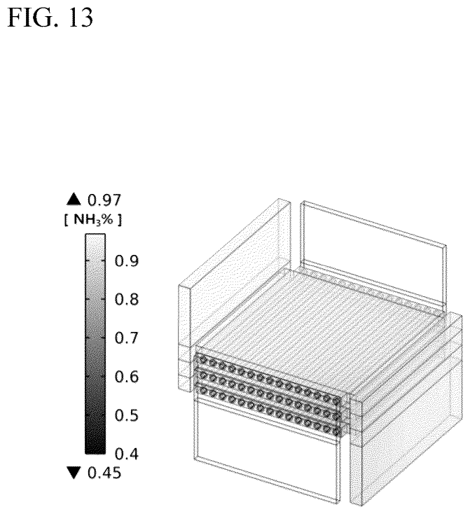

FIG. 12 is a modeling drawing showing a temperature distribution depending on ammonia reforming in Example 2 of the present disclosure in the COMSOL 3D Multiphysics simulation, and FIG. 13 is a modeling drawing showing an ammonia concentration distribution depending on ammonia reforming in Example 2 of the present disclosure in the COMSOL 3D Multiphysics simulation.

Details are shown in the following Table 2.

TABLE 2

| | Example 1 | Example 2 |
|---|---|---|
| Air temperature at air inflow part of manifold | 700 | 700 |
| (° C.) | | |
| Air temperature at air outflow part of manifold | 559 | 561 |
| (° C.) | | |
| Fuel temperature (A) at fuel inflow part of | 400 | 400 |
| manifold (° C.) | | |
| Fuel temperature (B) at fuel outflow part of | 599 | 602 |
| manifold (° C.) | | |
| (\|B − A\|/A)*100 (%) | 49.75 | 50.50 |
| Ammonia conversion rate(%) | 11.5 | 3.9 |

The conditions of a changed reforming rate were for confirming how a temperature change was thermally affected when the ammonia reforming reaction which is an endothermic reaction occurred much, and as a result of calculation, it was confirmed that there was no big difference in the temperature distribution depending on the reforming rate. That is, it was confirmed that heat exchange by a fluid flow at a high temperature and a fluid flow at a low temperature has a dominant effect on a temperature distribution.

As a result, it was found that ammonia reforming reaction performance did not have much effect in the present design and flow rate boundary conditions, and heat exchange by a manifold design is more important than a temperature lowered by ammonia reforming of the manifold in the stack of directly using ammonia.

### (3) Experimental Example 3—Comparison of Heat Exchange and Ammonia Conversion Efficiency Depending on Flow Rate Change

By comparing Example 1 in which the air utilization rate was assumed to be 100% and Example 3 in which the air utilization rate was assumed to be 10%, simulation was performed for confirming change of heat exchange and ammonia conversion efficiency depending on air flow rate change. For reference, simulation was also performed in Comparative Example 1 in which the air utilization was assumed to be 100% and Comparative Example 2 in which the air utilization rate was assumed to be 10%.

The simulation was performed with the other conditions remaining the same. It was assumed that the temperature of fuel put into the manifold was 400° C. and the temperature of air was 700° C., as in Example 1. In addition, detailed assumption conditions were as follows.
Assumption conditions of Experimental Example 3
Assuming fuel utilization rate of 50%
Assuming air utilization rate of 100% (Example 1 and Comparative Example 1), and air utilization rate of 10% (Example 3 and Comparative Example 2)

The air utilization rates of 100% and 10% means that the air flow rates were different as 9 liter/min and 90 liter/min. That is, in Example 3 and Comparative Example 2, the simulation was performed assuming that the air flow rates corresponding to 10 times those of Example 1 and Comparative Example 1 were supplied.

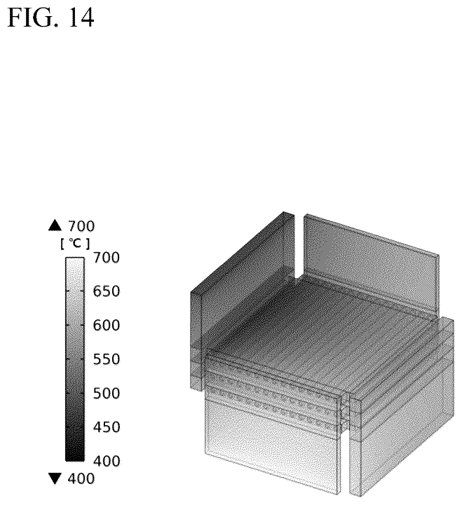

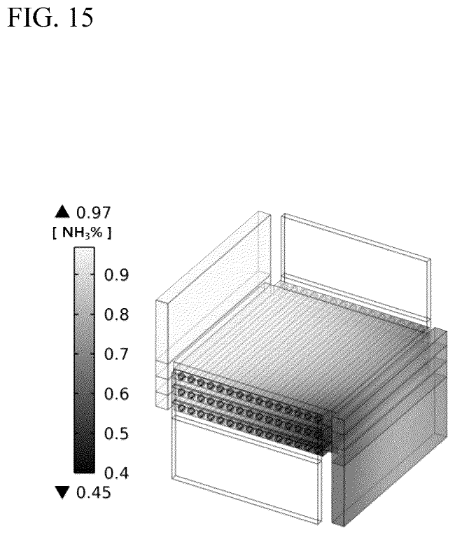

FIG. 14 is a modeling drawing showing a temperature distribution depending on ammonia reforming in Example 3 of the present disclosure in the COMSOL 3D Multiphysics simulation, and FIG. 15 is a modeling drawing showing an ammonia concentration distribution depending on ammonia reforming in Example 3 of the present disclosure in the COMSOL 3D Multiphysics simulation.

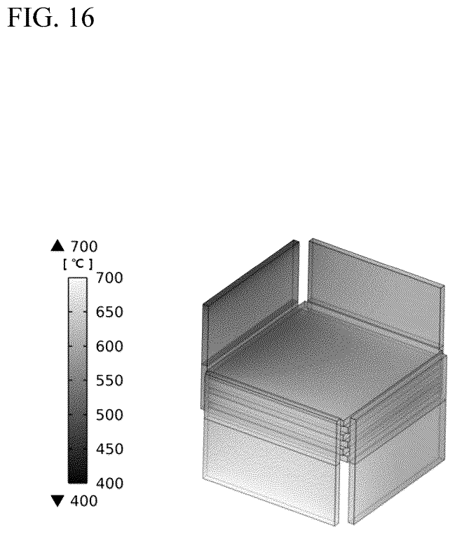

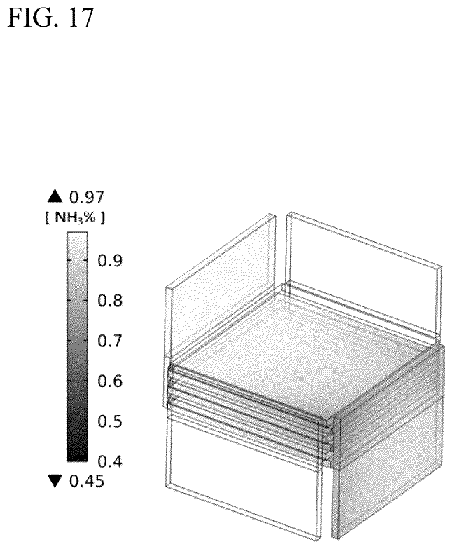

FIG. 16 is a modeling drawing showing a temperature distribution depending on ammonia reforming in Comparative Example 2 of the present disclosure in the COMSOL 3D Multiphysics simulation, and FIG. 17 is a modeling drawing showing an ammonia concentration distribution depending on ammonia reforming in Comparative Example 2 of the present disclosure in the COMSOL 3D Multiphysics simulation.

Details are shown in the following Table 3.

TABLE 3

| | Exam- | Exam- | Comparative | Comparative |
|---|---|---|---|---|
| | ple 1 | ple 3 | Example 1 | Example 2 |
| Air temperature at | 700 | 700 | 700 | 700 |
| air inflow part of | | | | |
| manifold (° C.) | | | | |
| Air temperature at | 559 | 673 | 583 | 677 |
| air outflow part of | | | | |
| manifold (° C.) | | | | |
| Fuel temperature (A) | 400 | 400 | 400 | 400 |
| at fuel inflow part | | | | |
| of manifold (° C.) | | | | |
| Fuel temperature (B) | 599 | 665 | 569 | 621 |
| at fuel outflow part | | | | |
| of manifold (° C.) | | | | |
| (\|B − A\|/A)*100 (%) | 49.75 | 66.25 | 42.25 | 55.25 |
| Ammonia conversion | 11.5 | 29.0 | 5.2 | 11.0 |
| rate(%) | | | | |

When the air flow rate assumed to be a high temperature fluid flow (hot stream) was increased, heat exchange efficiency was increased and the temperature rose, and the ammonia reforming reaction was also expected to be increased, and it was confirmed from the simulation results that as the high temperature air flow rate of the manifold rose, the heat exchange efficiency was increased, so that a fuel temperature rise degree was increased.

That is, it was confirmed that the temperature of fuel increased as the air flow rate at a high temperature was increased accelerated the reforming reaction and showed a high difference also in the simulation results. This was confirmed from Examples 1 and 3 and Comparative Examples 1 and 2 in common.

However, in the ammonia conversion rate, upon comparison of Example 1 and Example 3, when the air flow rate was increased by 10 times, it was confirmed that the ammonia conversion rate was increased by about 2.52 times, but upon comparison of Comparative Example 1 and Comparative Example 2, when the air flow rate was increased by 10 times, it was confirmed that the ammonia conversion rate was increased by about 2.12 times. That is, in the case of the tubular design model of the present disclosure, it was confirmed that an increase degree in the ammonia conversion rate by an increase in the flow rate was larger.

### (4) Experimental Example 4—Comparison of Heat Exchange and Ammonia Conversion Efficiency Depending on Capacity Change of Manifold

In the modeling of Example 1, the lower manifold 40 had the width×length of 175 mm×175 mm, the height of one stack where a plurality of branch tubes was positioned inside the fluid flow space was 13.0 mm, and a total of 3 stacks were laminated to form a height of 39.0 mm.

However, in Example 4, a total of 5 stacks were laminated, so that the manifold had a height of 65.0 mm. The other conditions were the same as those of Example 1.

By comparing Example 1 and Example 4, simulation was performed in order to confirm change in heat exchange and ammonia conversion efficiency depending on capacity change of the stack, that is, capacity change of the manifold.

In addition, in order to also confirm air flow rate change in the modeling in which the manifold capacity was increased as in Experimental Example 3, the simulation was also performed in Example 5 in which only the air utilization rate was changed to be an assumption of 10% (10 times the air flow rate). The other conditions were the same.

The temperature of fuel put into the manifold was assumed to be 400° C. and the temperature of air was assumed to be 700° C., as in Example 1. In addition, detailed assumption conditions were as follows.
Assumption conditions of Experimental Example 4
Assuming fuel utilization rate of 50%
Assuming air utilization rate of 100% (Example 1 and Example 4) and air utilization of 10% (Example 5)

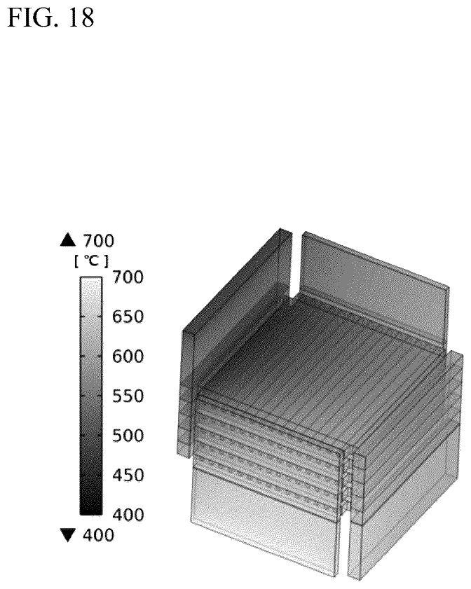

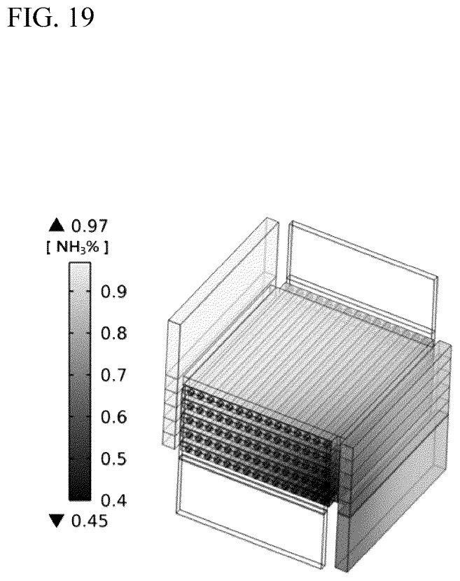

FIG. 18 is a modeling drawing showing a temperature distribution depending on ammonia reforming in Example 4 of the present disclosure in the COMSOL 3D Multiphysics simulation, and FIG. 19 is a modeling drawing showing an ammonia concentration distribution depending on ammonia reforming in Example 4 of the present disclosure in the COMSOL 3D Multiphysics simulation.

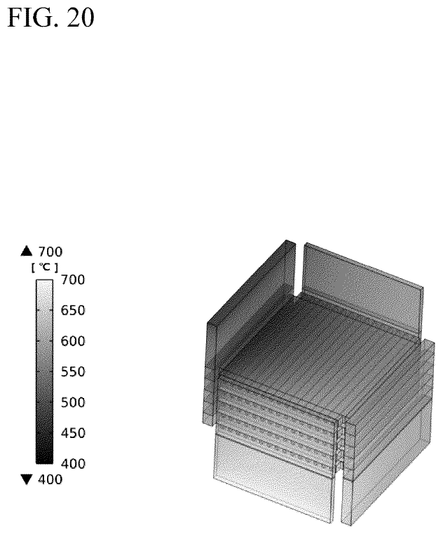

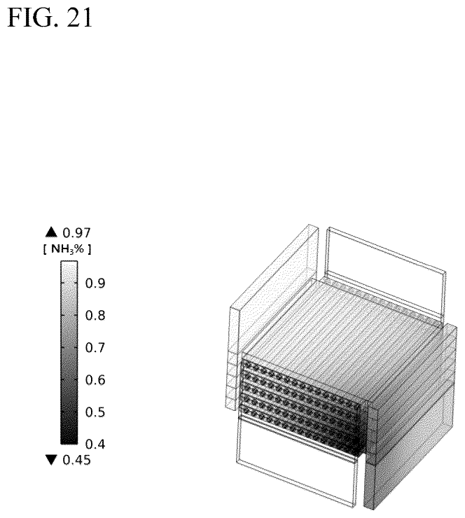

FIG. 20 is a modeling drawing showing a temperature distribution depending on ammonia reforming in Example 5 of the present disclosure in the COMSOL 3D Multiphysics simulation, and FIG. 21 is a modeling drawing showing an ammonia concentration distribution depending on ammonia reforming in Example 5 of the present disclosure in the COMSOL 3D Multiphysics simulation.

Details are shown in the following Table 4.

TABLE 4

| | Example | Example | Example |
|---|---|---|---|
| | 1 | 4 | 5 |
| Air temperature at air inflow part of | 700 | 700 | 700 |
| manifold (° C.) | | | |
| Air temperature at air outflow part of | 559 | 547.8 | 670.2 |
| manifold (° C.) | | | |
| Fuel temperature (A) at fuel inflow | 400 | 400 | 400 |
| part of manifold (° C.) | | | |
| Fuel temperature (B) at fuel outflow | 599 | 603.9 | 671.8 |
| part of manifold (° C.) | | | |
| (\|B − A\|/A)*100 (%) | 49.75 | 50.98 | 67.95 |
| Ammonia conversion rate(%) | 11.5 | 22.0 | 56.0 |

As the height of the manifold in Example 4 was increased by 1.67 times as compared with that in Example 1, it was confirmed that heat exchange efficiency was increased and an ammonia conversion rate was increased by 1.91 times.

In addition, by comparing Example 4 and Example 5, it was confirmed that the ammonia conversion rate was increased by 2.55 times due to an increased flow rate, as in Experimental Example 3. However, as described above, upon comparison of Comparative Example 1 and Comparative Example 2, the ammonia conversion rate was increased by about 2.12 times when the air flow rate was increased by 10 times. Therefore, it was confirmed that even when the capacity of the manifold was increased, the increase degree in the ammonia conversion rate by the increase in the flow rate was larger in the tubular design modeling of the present disclosure.

The present disclosure is not limited by the above exemplary embodiments and may be manufactured in various forms different from each other, and it may be understood that a person with ordinary skill in the art to which the present disclosure pertains may carry out the present disclosure in another specific form without modifying the technical idea or essential feature of the present disclosure. Therefore, it should be understood that the exemplary embodiments described above are illustrative and are not restrictive in all aspects.

### DESCRIPTION OF SYMBOLS

10: solid oxide fuel cell
20: upper manifold
30: repeating units of cells and separation plates
40: lower manifold
41: first stack of lower manifold
42: second stack of lower manifold
43: third stack of lower manifold
50: flow path extension
60: outermost part of assembly including a manifold and a flow path extension
210: fuel outflow tube
220: air inflow tube
410: fuel inflow tube
420: air outflow tube
510: air moving branch tube
511: surface layer of catalyst-uncoated branch tube
512: surface catalyst layer of catalyst-coated branch tube
1100: first flow path of air
1200: fifth flow path of fuel
2100: second flow path of air
2200: fourth flow path of fuel
2300: fourth flow path of air
2400: second flow path of fuel
3100: third flow path of air
3200: third flow path of fuel
3300: fifth flow path of air
3400: first flow path of fuel

What is claimed is:

1. A manifold for a solid oxide fuel cell comprising:
a first tube which is positioned on a side surface of the manifold and protrudes to the outside;
a second tube which is positioned on a side surface of the manifold different from the surface on which the first tube is positioned and protrudes to the outside of the manifold;
a fluid flow space connected to the first tube; and
a plurality of branch tubes connected to the second tube,
wherein the plurality of branch tubes is disposed inside the fluid flow space.

2. The manifold for a solid oxide fuel cell of claim 1, wherein:
a first fluid moving in the fluid flow space and a second fluid moving in the plurality of branch tubes move in a cross-over manner.

3. The manifold for a solid oxide fuel cell of claim 1, wherein:
heat exchange is performed between a first fluid moving in the fluid flow space and a second fluid moving in the plurality of branch tubes.

4. The manifold for a solid oxide fuel cell of claim 1, wherein:
when the first tube is an inflow tube of a first fluid,
the second tube is an outflow tube of a second fluid.

5. The manifold for a solid oxide fuel cell of claim 2, wherein:
when the first fluid is a raw material including ammonia,
the second fluid is heated air.

6. The manifold for a solid oxide fuel cell of claim 2, wherein:
a residence volume % of the first fluid moving in the fluid flow space is in a range of 40 to 90 volume % based on 100% of the volume of the manifold.

7. The manifold for a solid oxide fuel cell of claim 1, wherein:
an outer diameter of a single branch tube in the plurality of branch tubes is in a range of 1.0 to 20.0 mm.

8. The manifold for a solid oxide fuel cell of claim 1, wherein:
a catalyst coating layer is included on the inside or outside of the plurality of branch tubes.

9. The manifold for a solid oxide fuel cell of claim 1, wherein:
a catalyst is filled into the inside of the plurality of branch tubes or the inside of the fluid flow space.

10. The manifold for a solid oxide fuel cell of claim 1, wherein:
the plurality of branch tubes is formed of one or more metals selected from the group consisting of iron (Fe), nickel (Ni), chromium (Cr), ruthenium (Ru), cobalt (Co), molybdenum (Mo), osmium (Os), platinum (Pt), and copper (Cu).

11. A method for reforming ammonia using a manifold for a solid oxide fuel cell which is the manifold for a solid oxide fuel cell of claim 1, the method comprising:
flowing ammonia into a first tube,
wherein a temperature at an inlet and a temperature at an outlet of a fluid flow space of ammonia satisfy the following Equation 1:
$$30. \% \leq ( \vert B - A \vert / A ) * 100 \leq 200. \% \qquad [ Equation 1 ]$$
wherein A is the temperature (° C.) at the inlet of the fluid flow space of ammonia, and
B is the temperature (° C.) at the outlet of the fluid flow space of ammonia.

12. The method for reforming ammonia using a manifold for a solid oxide fuel cell of claim 11, wherein:
the temperature at the inlet of the fluid flow space of ammonia is in a range of 20 to 600° C., and
the temperature at the outlet of the fluid flow space of ammonia is in a range of 400 to 1100° C.

13. The method for reforming ammonia using a manifold for a solid oxide fuel cell of claim 11, wherein:
an ammonia conversion rate inside the manifold satisfies the following Equation 2:
$$15 \% \leq 100 * ( C - D ) / C \leq 100 \% \qquad [ Equation 2 ]$$
wherein C is a supply ammonia flow rate (L/min) at a manifold inflow position of fuel, and
D is a residual ammonia flow rate (L/min) at a manifold outflow position of fuel.

14. A solid oxide fuel cell comprising:
an upper manifold;
repeating units including cells and separation plates; and
a lower manifold,
wherein the lower manifold is the manifold of claim 1, and
the repeating units include a first fluid channel connected to the upper manifold and the lower manifold and a second fluid channel connected to the upper manifold and the lower manifold.
